(19) United States
(12) Patent Application Publication
(10) Pub. No.: US 2012/0054096 A1
(43) Pub. Date: Mar. 1, 2012

(54) SYSTEM AND METHOD FOR INTRA- AND INTER-JURISDICTIONAL COLLECTION AND DISTRIBUTION OF FUNDS

(76) Inventors: John A. Burega, Oakville (CA); James R. Millership, Toronto (CA)

(21) Appl. No.: 13/320,056

(22) PCT Filed: May 11, 2010
(86) PCT No.: PCT/CA2010/000702

§ 371 Date: Nov. 11, 2011

Related U.S. Application Data
(60) Provisional application No. 61/177,248, filed on May 11, 2009.
(60) Provisional application No. 61/264,298, filed on Nov. 25, 2009.

(51) Int. Cl. G06Q 20/10

(52) U.S. Cl. 705/39

(57) ABSTRACT

Systems, methods, devices, and computer programming product for electronic funds collection, transfer and administration using a computer network, including particularly the collection of funds from multiple jurisdictions for distribution to charities, such as disaster or poverty relief, and/or or to public works projects or other causes in single or multiple jurisdictions, which may or may not include jurisdictions in which the funds are collected.

### CROSS-REFERENCE TO RELATED APPLICATIONS

This application claims the benefit of U.S. provisional patent application Ser. Nos. 61/177,248, filed 11 May 2009; and 61/264,298, filed 25 Nov. 2009; both entitled “Inter- and Intra-jurisdictional Collection and Distribution of Funds.” The entire contents of both applications, including any attached appendices, is incorporated herein by this reference.

### DISCLAIMERS

This application contains material describing the transfer and/or distribution of charitable and other funds between entities and jurisdictions. The transfer of funds between entities and jurisdictions is in some cases regulated by governmental and other agencies. The disclosure herein is made solely in terms of logical, administrative, economic, and charitable possibility, without regard to possible statutory, regulatory, or other legal considerations. Nothing herein is intended as a statement, suggestion, or representation that any system, method or process proposed or discussed herein does or does not comply with any statute, law, regulation, or other legal requirement in any jurisdiction; nor should it be taken or construed as doing so.

A portion of the disclosure of this patent document may contain material which is subject to copyright protection. The copyright owner has no objection to the facsimile reproduction by anyone of the patent document or the patent disclosure, as it appears in the Patent and Trademark Office patent files or records following publication, but otherwise reserves all copyrights whatsoever.

### BACKGROUND AND SUMMARY OF THE INVENTION

The invention provides systems, methods, devices, and computer programming product for electronic funds collection, transfer and administration. More particularly, the invention provides systems, methods, devices, and computer programming product for collecting and distributing charitable and other funds over a computer network.

In various preferred embodiments, the several aspects of the invention provide systems, methods, and computer programming product for collecting funds from multiple jurisdictions for distribution to charities, such as disaster or poverty relief, and/or or to public works projects or other causes in single or multiple jurisdictions, which may or may not include jurisdictions in which the funds are collected.

In various embodiments the several aspects of the invention may, for example, be implemented in the form of single- or multi-tiered collection systems suitable for use in, for example, implementing multi-jurisdictional charitable subscriber lotteries, and systems and software for implementing such lotteries. In such embodiments funds collected in accordance with the descriptions herein can be distributed both to lottery winners and to other distributees, such as charities, public works agencies, and/or other causes. Distributions to such causes can be made with or without regard to the jurisdiction(s) in which funds are raised.

For example, in various aspects the invention provides systems, methods, and computer programming product useful for distributing to two or more parties funds collected from any one or more of a variety of sources. The parties to whom the funds are distributed can be located in or otherwise subject to or associated with laws, regulations, and/or communications protocols of one or more of multiple jurisdictions. Such funds can be distributed to such parties in accordance with predetermined schemes, protocols, and/or algorithms implemented by one or more data processors communicatively linked to one or more networked computer communications systems. Such schemes, protocols, and/or algorithms can be wholly or partially structured to accommodate any applicable law(s) and/or regulation(s).

In various further aspects the invention provides systems, methods, and computer programming product for collecting funds for distribution to two or more parties according to predetermined protocols implemented by networked computer communications systems.

In further embodiments, the invention provides methods, software, and other components for implementing the various functions and processes described herein.

These and other aspects and embodiments of the invention are further described in the disclosure which follows.

### BRIEF DESCRIPTION OF THE DRAWINGS

The invention is illustrated in the figures of the accompanying drawings, which are meant to be exemplary and not limiting, and in which like references are intended to refer to like or corresponding parts.

FIG. 1 is a schematic diagram of an embodiment of a computer communications and/or other data processing network suitable for use in collecting and distributing funds in accordance with various aspects of the invention.

FIG. 2 is a schematic diagram of embodiments of tickets or other receipts issued by local collection and distribution systems in accordance with various aspects of the invention.

FIGS. 3-5 are schematic diagrams of embodiments of computer communications and data processing networks suitable for use in collecting and distributing funds in accordance with various embodiments and/or aspects of the invention.

FIG. 6 is a schematic flow diagram illustrating a process for collection and distribution of funds in accordance with aspect of the invention.

### DETAILED DESCRIPTION OF THE PREFERRED EMBODIMENTS

Preferred embodiments of methods, systems, and apparatus according to the invention are described through reference to the drawings.

System Components

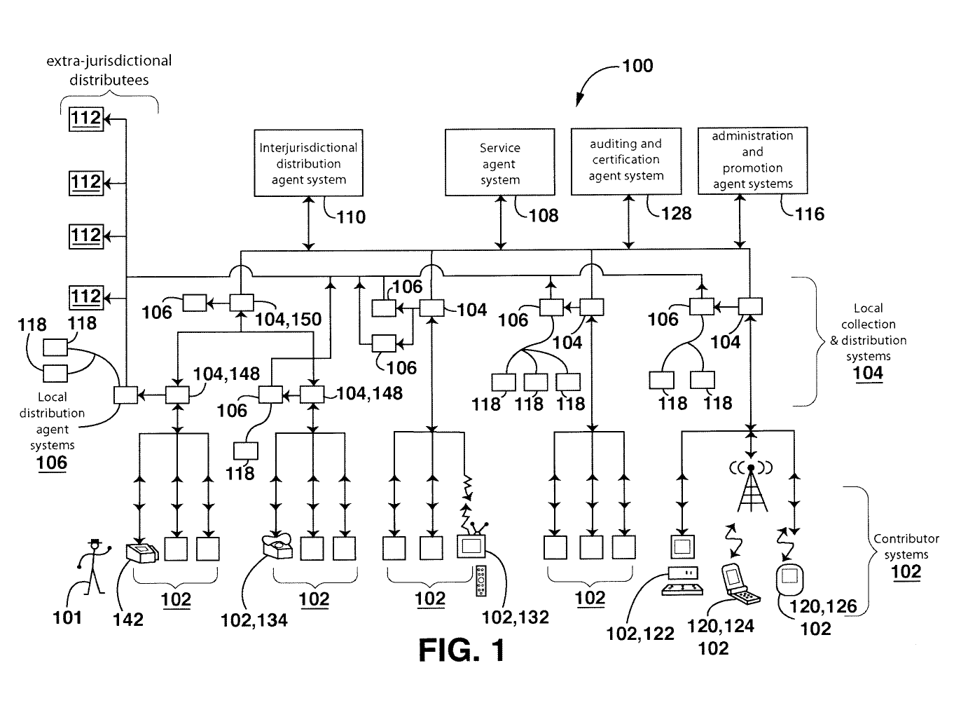

FIG. 1 is a schematic view of an embodiment of a computer communications network, i.e., an electronic signal communications network adapted for communications and control by and between a plurality of automatic data processors, 100, comprising components suitable for use in implementing various aspects of the invention(s) disclosed herein.

The embodiment of the network 100 shown in FIG. 1 is suitable for use in, for example, distributing to various parties and/or party-related communications (sub)systems funds collected from a variety of sources. The parties to whom such funds are distributed can be located in or otherwise subject to laws, regulations, and/or other protocols of single or multiple jurisdictions. Funds can be distributed to such parties in accordance with predetermined protocols implemented by networked computer communications systems.

In the embodiment shown, system 100 comprises a plurality of contributor (sub)systems 102; a plurality of local collection and distribution (sub)systems 104; a plurality of local (i.e., intrajurisdictional) distribution agent (sub)systems 106; one or more service agent (sub)systems 108; one or more interjurisdictional distribution agent (sub)systems 110; one or more local distributee (sub)systems 118; one or more extrajurisdictional distributee (sub)systems 112; one or more auditing or certification agent (sub)systems 128; and one or more administration and promotion agent (sub)systems 116.

As will be immediately understood by those skilled in the relevant arts, once they have been made familiar with this disclosure, various of the components 102, 104, 106, 108, 110, 112, 118, 116 of system 100, are optional, depending upon the embodiments of the invention one wishes to implement. As will be further apparent to those so skilled, and or all of such compontents may be provided as separate, distinct machines, systems, or subsystems, or may be combined in any suitable or desired fashion, including any suitably-configured shared or distributed processing schemes. For example, processing performed by or on behalf of any one or more of the components 102, 104, 106, 108, 110, 112, 118, 116 etc. may be performed wholly locally and/or through various shared or distributed processing schemes. In implementing the various embodiments of the invention such components may be included, or not included, in any desired or otherwise suitable numbers or combinations, in order to accomplish various purposes described herein. As will be made apparent herein, such systems can be implemented using very small numbers of such components, or very large and complex systems of such components, or in any numbers in between.

As will further be apparent to those skilled in the relevant arts, the distinction between systems and subsystems is in many cases a matter of purpose, perspective, and or semantics, and is sometimes determined to at least some extent by the type and nature of authority exercised by various distinct parties or entities in controlling processing performed by such (sub)systems. The functions of such systems and/or subsystems can be performed using various combinations of hardware and/or software. To the extent not inconsistent with the various purposes and objectives suggested or disclosed herein, or otherwise required by context, the terms ‘system’ and ‘subsystem’ are used interchangeably herein.

Contributor systems 102 are used for generating signals by or on behalf of contributors 101 such as private individuals, businesses, charities, their agents, and/or others to provide electronic signals representing funds to local collection distribution system(s) 104, and/or to other components 110, 108, 128, 116, etc. of the system 100. Such signals representing such funds can be provided in any of a wide variety of ways, including for example through the use of debit or credit cards, electronic transfers, and/or other access to electronic funds accounts. Systems 102 can comprise any suitable input and/or other means for accessing such funds in order to make such collections and forwarding collected funds in electronic format to further components or entities, such as local collection and distribution systems 104. For example, contributor systems 102 can comprise desk- or countertop systems 142 provided by storefront collections operators (which might include, for example, card reading devices and/or other input/output devices, such as display screens and keyboards), home computer systems such as personal computers (PCs) 102, 122 linked to the Internet or other communications system, handheld or other wireless and/or mobile communications devices 120 such as palmtop computer systems 126 or cellular telephones 124; interactive televisions (ITVs) 132, landline telephones 134, and/or wireless or other handheld point of sale devices such as handheld funds processors and receipt/ticket printers.

Local collection and distribution systems 104 receive funds electronically from contributor systems 102 and in some embodiments remit payments to contributors through the same or other system(s) 102. Each system 104 is typically, but not necessarily always, associated with one or more regional collection and remittance authorities. For example, in embodiments of the invention implementing collection and/or distribution schemes comprising multijurisdictional drawings, local collection and distribution systems 104 can comprise networked processors operated by or on behalf of privately-, publicly, and/or charitably-owned/controlled/operated local, regional, provincial, and/or national lotteries. In such embodiments a system 104 can, for example, provide to a contributor providing funds through a local collection system 102 a ticket or other receipt comprising an identifier or other device suitable for use in evidencing contribution in the form of participation in a lottery or other drawing.

In various embodiments of the invention which implement lotteries as part of a funds collection and distribution scheme, individual local collection and distribution systems 104 can operate their own lotteries. In the same and other embodiments pluralities of local collection and distribution systems 104 can operate combined lotteries, as described herein, for example. Thus, as shown for example in FIG. 1, local collection and distribution systems 104 can exist in multiple layers.

In various embodiments of the invention, including those which implement various forms of lottery schemes, local collection and distribution systems 104 can remit funds collected through contributor systems 102. Such funds can, for example, be remitted to one or more individual contributors whose participation in a lottery is evidenced by a ticket or other receipt issued to them. In such embodiments local collection and distribution systems can also perform lottery implementation functions. For example, in embodiments in which one or more of local collection and distribution systems 104 comprise local, regional, provincial, and/or national charitable or other lottery systems, the systems 104 can administer the lottery and select distributees, i.e., winners, from among those participants who have purchased tickets or otherwise contributed funds.

In the same and other embodiments, local collection and distribution systems 104 can, through the use of suitably-configured electronic signals, remit funds to local (i.e., intra-jurisdictional) and/or extra-jurisdictional charities, public works, or other distributees 118. Such distributions can be made, for example, through local distribution agent systems 106.

Local distribution agent systems 106 can receive signals representing funds provided by local collection and distribution systems 104 or other components of system 100 for application to predetermined or otherwise-selected causes, either directly or through further entities or agents. Recipients of such funds from local distribution agent systems 106 can, for example, include one or more local distributees associated with local distributee system(s) 118, such as local charities and/or local public works such as schools, healthcare projects, roads, water, transit, or other infrastructure projects. Local distribution agent systems 106 can distribute such funds directly or indirectly, using for example banks, trusts, charities, or other parties to assist in the transfer or distribution of funds. Thus local distribution agent systems 106 can also act as trusted agents for receipt and transfer of funds from local collection and distribution systems 104 or other components of system 100, in holding and transferring funds to various components or entities, including for example any one or more of systems 110, 108, 116, 128. As may be seen in FIG. 1, one or more local distributees 118 can be associated with each local collection and distribution system 104.

Local collection and distribution systems 104 may also be associated with, and directly or indirectly remit funds to, one or more extrajurisdictional distributee systems 112, which can for example be associated with charities and/or public works projects subject to regulation or control in jurisdictions other than those in which funds have been collected by any one or more of local collection and jurisdiction system(s) 104. For example, such funds can be indirectly distributed through the services of one or more agent systems 110.

Service agent system(s) 108 can provide any of a wide variety of administrative and/or managerial services to local collection and distribution system(s) 104 and/or to other components of system 100, as desired. For example, service agent systems 108 can provide guidance and/or assistance to any or all of local collection and distribution system(s) 104, or distributees 106, 112 in the collection, control, and remittance of funds. Such guidance can, for example, include determination of the identities of contributors and/or distributees 106, 112, 118 who are to receive remittance from the various components of system 100, and/or the amounts to be remitted to such parties, and the timing of such remittances. As a further example, service agent system(s) 108 can interact with one or more of auditing and certification agent systems 128; for example system(s) 108 can provide to and receive from any such system(s) 128 files comprising data and/or protocols used in the determination of winners 101 or other distributees 110, 112, 106, 118, etc.

As a further example, in embodiments of the invention adapted for the collection and distribution of funds through a lottery or other drawing schemes, service agent system(s) 108 can apply random and/or other agreed or approved algorithms or processes to the selection of lottery winners (i.e., distributees) from among contributors 101 of funds. For example, contributors 101 of funds through the various contributor systems 102 can be assigned tickets or other receipts bearing identifier(s) generated or otherwise provided by one or more corresponding local collection and distribution system(s) 104, and redeemable at, for example, any one or more of systems 102, 104; and at an appointed time or under other predetermined conditions service agent system 108 can select one or more of such identifiers in order to identify one or more winners of an amount of funds to be remitted to the holders of tickets or receipts bearing selected identifiers. The selected identifier(s) can then be communicated by the service agent system 108 to the corresponding local collection and distribution system(s) 104 (e.g., the system(s) 104 that generated and/or assigned the selected identifier(s) to the ticket(s) and provided them to the corresponding contributor(s)), whereupon the corresponding local collection and distribution system(s) 104 can, directly or through further agents, remit to the holder(s) of the winning receipt(s) a determined amount of funds, electronically or in cash or other form.

In such embodiments, one or more of local collection and distribution agent(s) 104, or other agencies, can assign numbers or other identifiers to individual contributor(s)/participant(s) 101, and deliver flat files or other data structures comprising pools or ranges of possible winning identifiers to the agent (e.g., agent 108) designated to identify one or more winning distributees, and/or to any auditing and certification agent system(s) 128 and/or other components of system 100; and the responsible agent can designate one or more winners 101 from the pool(s) provided in such data structure(s).

As a further example, in embodiments of the invention in which system 100 is adapted for the collection and distribution of funds through a lottery or other drawing scheme, one or more of local collection and distribution system(s) 104 can apply random and/or other agreed or approved algorithms or processes to the selection of lottery winners from among contributors 101 of funds. For example, contributors 101 of funds through the various contributor systems 102 can be assigned tickets or other receipts bearing identifier(s) generated or otherwise provided by one or more corresponding local collection and distribution system(s) 104, and at an appointed time or under other predetermined conditions one or more of local collection and distribution system(s) 104 can select one or more of such identifiers in order to identify one or more winners of an amount of funds to be remitted to the holders of tickets or receipts bearing selected identifiers. The selected identifier(s) can then be communicated by the local collection and distribution system(s) 104 to the corresponding service agent system(s) 108 (e.g., the system(s) and/or other components, such as auditing and certification agent system(s) 128, whereupon the corresponding local collection and distribution system(s) 104 or other agent, including for example interjurisdictional distribution agent system 110 and/or local distribution agent system(s) 106 can, directly or through further agents, remit to the holder(s) of the winning receipt(s) 101 a determined amount of funds, electronically or in cash or other form.

In such embodiments one or more of local collection and distribution agent(s) 104, or other agencies, can for example assign numbers or other identifiers to individual contributor(s)/participant(s) 101, and deliver flat files or other data structures comprising identifiers of winning contributors 101 to the agent (e.g., agent 108) designated to remit distributions to the winner(s) and/or other distributees, and/or to any auditing and certification agent system(s) 128 and/or other components of system 100.

As will be understood by those skilled in the relevant arts, once they have been made familiar with this disclosure, flat files and other data structures comprising a wide variety of data relating to the identification and/or selection of winners and/or other distributees can be provided to service agent system(s) 108, auditing and certification agent system(s) 128, and/or to other components of system 100 in order to satisfy or otherwise comply with any applicable regulatory, accounting, archiving, or other data processing requirements.

In the same or other embodiments one or more of contributors 101 can be identified as prize winners in “instant win” schemes, whereby, for example, a ticket or other receipt provided to one or more contributor(s) 101 comprises “scratch and win” and/or other device(s), and/or instantly-applied random or pseudo-random processes can be used, to identify winners in real time at the time of contribution/ticket purchase, or following any desired regular or ad hoc delay.

Interjurisdictional distribution agent systems 110 can receive funds from one or more local collection and distribution system(s) 104 (directly or through any suitable agents) for holding and distribution to distributees such as one or more of extrajurisdictional distributees 112, local distributees 118, and/or to identified contributor(s) 101. Interjurisdictional distribution agent systems 110 can include, for example, trusted agents such as banks or trust entities designated to hold funds for remittance to identified distributees in trust until remitted to the designated distributees. Local distribution agent systems 106 can act as local counterparts to interjurisdictional agents 110 with respect to, for example, any one or more of systems 104, 112, 118.

Local distributee systems 118 can include (sub)systems operated by or on behalf of local charities and/or local public works such as schools, healthcare projects, roads, water, transit, or other infrastructure projects. As may be seen in FIG. 1, one or more local distributees can be associated with one or more local collection and distribution systems 104. Remittances made to such distributees can be made in electronic form, or by check or other instrument, or in any other suitable manner.

Extrajurisdictional distributees 112 can include any suitable distributees outside any or all of the jurisdictions in which collections are made by, for example, local collection and distribution systems 104. Examples can include global or International disaster relief funds, local charities, health, and/or other public works organizations outside the jurisdiction(s) in which collections are made, or other suitable or agreed recipients of funds collected via system 100.

One of the many advantages offered by the invention is that it makes available large-scale charitable or other relief on a short timeline, in a form which can rapidly and effectively be collected from a geographically-, economically, and socially diverse sources and delivered to the cites or victims of disasters, or to charities, and/or other causes worldwide. For example, in embodiments of systems 100 configured for implementation of global or large-scale international lottery schemes, which may for example be referred to as “World Lottery Draws,” hundreds of millions of dollars, or more, in electronic or other forms of currency and/or goods or services, can be collected on a short-term ad hoc or periodic basis, and made available almost instantaneously to any of a very wide variety of worthy recipients in a very wide variety of forms, through the use, for example, of electronic funds transfer.

As noted above, distributions made in accordance with the invention, both to winning or otherwise-identified contributors 101 and/or distributees 112, 118 can be provided in any suitable form, including for example currency (electronic or otherwise), goods, and/or services. Suitable forms of distributions may include, in various embodiments, any objects or indicia of value, including for example cash, monetary cash equivalent such as electronic funds or accounts, gift or other value cards, goods or commodities of any type, and/or coupons or value represented by, for example, promotional codes. Distributions in any such form(s) may be made to any distributees, including for example contributor(s) 101, distributees 112, 118, and/or other entities, participants, or individuals associated with any of the various entities or systems identified in FIG. 1. This can include, for example, winners of jackpot and/or instant win prizes, and/or any causes 112, 118.

Distributions made by agents 106, 110 can be made on regular and/or ad hoc bases, as desired, depending upon the type(s) of collection and/or distribution schemes implemented by the various components 104, 108, 110, etc.

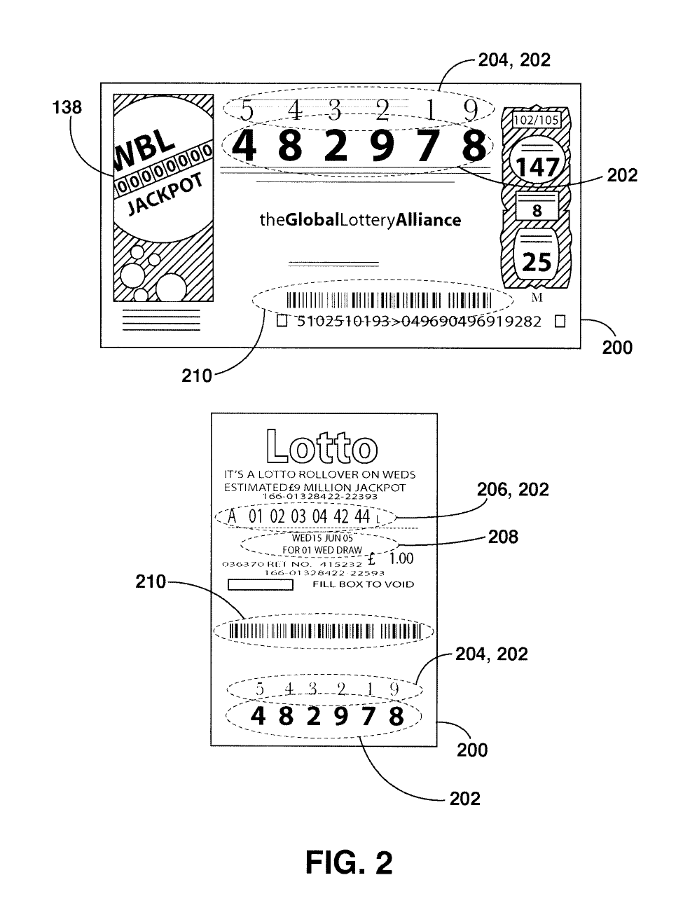

One particularly advantageous form of distribution, in embodiments of the invention which comprise lotteries, draws, or other single- or multi-tier mechanisms for returning some portion of collected contributions to one or more individual contributors 101, involves the provision, with the purchase or other provision of a receipt, ticket, or other rights such as a ticket 202 shown in FIG. 2, of rights to participate both in one or more single- or multi-tier drawings and a chance to receive an ‘instant win’ distribution, in form of currency or goods. In such an embodiment, for example, one portion of a contribution made by a contributor 101 can be designated for participation in and distribution in accordance with a first-level drawing, and a second portion can be designated for participation in and distribution in accordance with one or more instant-win distributions. In addition, 2^{nd}- or higher-tier drawings can be provided, with 2^{nd}- or higher-tier instant wind drawings.

Audit and/or certification agent system(s) 128 can be configured to provide independent or other wholly or partially automated audit and/or certification functions for any or all collection and/or distribution processes provided by any or all of the various components 102, 104, 106, 108, 110, 112, 118, etc., of system 100, and report to any one or more jurisdictions in which any of such components collect or distribute funds. For example, in embodiments of system 100 adapted for the implementation of lottery or other fiduciary-related distribution schemes, one or more systems 128 can be provided for fully and/or partially automated auditing or certification functions, including accounting, efficiency, fairness, regulatory, and other functions. Such processes can involve the receipt of flat files and/or other data structures comprising data representing relevant numbers, identifiers, protocols, or other processes from, and provision of such data structures to, any one or more of components 104, 106, 108, 110, 116, 112, 118 etc.

Administration and promotion system(s) 116 can comprise any number of further administrative, informational, promotional, and/or other services provided on behalf or at the request of any of the parties involved with systems 102, 104, 106, 108, 110, 112, 118, etc., of or associated with system 100. For example, referring web or print resources such as Internet web browsing or search engines, telephone or other communications servers, etc., can be exploited to provide promotional, informational, referral, or other services for any of such parties.

As will be understood by those skilled in the relevant arts, the collection and distribution, and/or other transfer or administration, of electronic funds, may be implemented using a wide variety of known security, communications, and other protocols and systems, which can relate for example to encryption, translation, and currency exchange processes. A wide variety of such systems and protocols are now known, and doubtless others will hereafter be developed.

Drawings/Lotteries

Single-tier

In various embodiments, as noted, collection and distribution processes according to the invention can be implemented in the form of drawings such as lotteries and/or instant win schemes. In such embodiments, the drawings or lotteries can be single- or multi-tiered. For example, any one or more of local collection and distribution systems 104, including for example single-jurisdiction controller(s) 148 and one or more levels of multi-jurisdiction controller(s) 150 can operate a single tier drawing by, for example, issuing to contributors receipts in a form such as that shown for one of tickets 200 of FIG. 2, and executing a drawing to determine one or more winners from among the contributors, using, for example, known lottery, drawing, and/or instant win processes. A portion of the pooled proceeds collected from participant-contributors 101 in the relevant jurisdictions can be remitted to such winner(s) as an award, with another portion or portions of the proceeds being awarded to one or more distributees 106, 112 for distribution to charities, public works or healthcare projects, or other causes in one or more of the same and/or other jurisdictions.

Ticket-receipts 200 of FIG. 2 can comprise one or more identifiers 202 assigned by the collection and distribution system 104 administering the drawing and used in determining a winner. Such identifiers can be determined, for example, using random number generating schemes and uniquely assigned to tickets issued by the respective collection and distribution system 104, as for example by printing on a paper ticket, as shown, and/or by associating the assigned identifier(s) with one or more unique data records identifying individual contributors where, for example, funds are remitted by the contributor(s) in electronic form.

Identifiers 202 can be provided in any suitable form, including any suitable human- and/or machine readable form, including for example printed text, bar-codes, RFID chips, etc.

Multi-Tier

Alternatively, such embodiments may be implemented in the form of multi-tier drawings. For example, a single-tier drawing such as that described above may be implemented by a local collection and distribution system 104, 148. In addition, a second-tier (or higher) drawing may be implemented through one or more of (a) the same local collection-distribution system 104 that implemented the single-tier drawing, (b) one or more of Interjurisdictional collection-distribution systems 150, and/or (c) one or more service agent system(s) 108.

For example, a purchaser of a ticket/receipt 200 from a local collection-distribution system 104 can be provided an option for purchasing a right or otherwise contributing to a second- or other tier drawing by, for example, providing an additional or incremental contribution. The purchase of such higher-tier rights is sometimes referred to as purchasing a ‘kicker’ ticket. The contribution made in return for the first-tier drawing can be placed into a first funds pool administered by, for example, the administering system 104 and/or its agent. The incremental additional contribution provided for participation in the second- or higher tier drawing can be placed in a separate funds pool administered by, for example Interjurisdictional distribution agent system 110 under the management of any one or more of systems 104, 108.

Contributors to such higher-tier drawings can be provided receipt-tickets 200 comprising identifiers placed into the consideration list for a higher-tier drawing administered by one or more of systems 104, 108. For example, a kicker-ticket identifier 204 can be issued, according to a protocol agreed to and accepted by relevant participating systems 104, 108 and provided on a paper and/or electronic receipt 200 and added to the list of possible winners of the higher-tier drawing. Such higher-tier identifier 204 can be a separately-assigned identifier. Alternatively, the same identifier 202 used in the first-tier drawing may be used by simply being added to the list of eligible higher-tier participants.

Drawings for such higher-tier collection and distribution processes can be carried out by any one or more of systems 104, 108, 110, 116, 128, etc. For example, using known or otherwise accepted random-number selection algorithms working on a defined set of numbers, a service agent 108 can select a winning number 204 selected from a range of numbers identified as possible according to the agreed protocol (e.g., in one or more flat files or other data structures provided by one or more of collection and distribution system(s) 104), and inform any one or more participating collection-distribution systems 104 of the winning selection(s), subject to auditing/confirmation by one or more of systems 128, which can be associated with any one or more jurisdictions, by, for example, use of such flat files.

Additionally or alternatively, as mentioned, an ‘instant win’ notifier or device may be provided on the receipt 200. For example, at the time of purchase of a first- or higher-tier right (e.g., ticket), an issuing system 104 can access an instant-win algorithm provided by an agent such as agent 108 (and suitably audited by one or more of systems 128) and print, at the time of issuance, a notifier (not shown) on the ticket 200 indicating that the purchaser has won an award to be paid immediately. In further embodiments, a ‘scratch and win’ or other pre-printed or otherwise pre-determined or pre-established device 138 such as that shown in FIG. 2 may be provided on the ticket/receipt 200.

In embodiments of the invention which implement ‘instant win’ or other schemes or mechanisms involving the distribution of prizes in the form of goods, the source(s) of such prizes can be of any of a very wide variety of types. As one particular example, prizes in the form of goods can be provided by distributees 112, 118, including for example charitable organizations who themselves are to be included in distributions of funds collected in accordance with the invention. For example, a distributee 112, 118 who is a wildlife protective organization can provide stuffed animals as instant win prizes. As another example, a charitable organization associated with a for-profit entity can provide samples of goods normally sold by the for-profit entity. For example, a charitable entity associated with a soft-drink manufacturer can provide a quantity of the manufacturer's soft-drink products for distribution as instant prizes to one or more ‘instant prize’ winners of a lottery or drawing scheme implemented in accordance with the invention.

In embodiments of system(s) 100 used for the distribution of physical goods (including physical forms of currency), one or more service agent system(s) 108 can comprise functionality interfacing with systems operated by, or otherwise enabling the distribution of such goods using, for example, any suitable governmental postal systems and/or private courier systems.

The selection of one or more winning identifiers 204 by the managing system 104, 108 in embodiments comprising jackpot drawings can result in no winners being identified, a single winner being identified, or multiple winners being identified. For example, in a two-tier drawing involving a plurality of participating collection-distribution systems 104, a single winning identifier may be selected by an administering service agent system 108. Such winning identifier may be communicated to each of the participating collection-distribution systems 104. Depending upon the protocol used by participating systems 104 to assign identifiers 204 to the respective contributors, it is possible that contributors participating through more than one local collection and distribution system 104 may have identical identifiers 204. In such case each of the contributors issued receipts bearing the selected identifier 204 may be declared a winner and participate in distribution of some designated portion of the pooled funds gathered with respect to the drawing.

In cases in which no winner is identified, funds collected by the various systems 104 can be held, or rolled over for distribution according to a later-initiated process, including for example a later or subsequent drawing.

Pooled or other collected funds, including for example jackpots and other drawing awards, may be collected and awarded on any desired or suitable ad hoc, periodic, or other basis. For example, in some embodiments of the invention jackpot drawings can be conducted on a quarterly basis for distribution of a predetermined percentage of collections (e.g., 75%) made during the quarter, with an annual drawing for distribution of a larger set of distributions (e.g., the entire final quarter's collections, plus the 25% reserved from the earlier quarterly jackpots). In further embodiments, aggregated or other pooled funds may be provided to instant distribution winners on an escalating weekly, monthly, annual, and/or other periodic basis. Such embodiments of the invention can comprise jackpot management programs, whereby accumulated jackpots exceeding selected jackpots threshold (ie. maximum $500 million) may allocated toward (i) $1 million or other value dollar instant winners (ii) on a first, e.g., annual basis, and further accumulated “super” jackpots that increase jackpot levels above the same or other selected thresholds on a different period basis, e.g., throughout the year (iii) to smaller instant cash prizes and (iv) other tiered prizes.

In these or other embodiments, prices for tickets (e.g., suggested contributions from contributors 101) can be varied in order to accomplish various purposes or results. For example, as the date of a drawing approaches and potential winnings increase, the price of tickets for participating may be increased. Ticket prices may be set on absolute or calendar bases, and/or may be tied to possible winnings and/or jackpot levels. Alternatively, as a draw date approaches, the cost of participating/expected contribution(s) can decrease. As will be understood by those skilled in the relevant arts, such mechanisms can be used to encourage participation and increased contributions. For example, the odds of winning may be tied to how close a ticket is purchased in relation to the draw date. ie. the ticket is higher price the further away from the draw date but the odds of winning are much greater. As ticket price declines and time to draw date is reduced the odds of winning decrease.

In further embodiments comprising drawings, in addition to jackpot winnings, one or more additional contributor(s) 101 or other distributees may be designated as winners of further prizes. For example, a predetermined number of non-jackpot winning distributees can be identified as winners of predetermined, set amounts or percentages of pooled contributions.

Thus, for example, in various aspects the invention provides the possibility (among others) of globally-progressive jackpot drawings driven through the use of add-on products such as kicker tickets. In one example, a $100 million minimum jackpot prize is provided with ten or more $1 million first-level sub-prizes being awarded to further contributors. As will be understood by those skilled in the relevant arts, once they have been made familiar with this disclosure, multiple levels of sub-prizes may be distributed (i.e., a single jackpot winner, three second prizes, 10 third prizes, etc.), in the form of money, goods, and/or services.

Receipts 200 may further comprise identifiers 206 assigned in further-tier drawings, information items 208 identifying the date, time, etc., of the respective drawings, and or other information or data items as desired, including for example machine-readable data items 210 such as bar codes.

As noted, any desired number of tiers may be provided in drawings through, for example, the provision of multiple tiers such as those formed by collection and distribution systems 104, 148, 150, and ‘instant win’ prizes and other distributions can be awarded at any one or more levels of distribution. For example, a single ‘instant win’ identifier 202, 204 can be entered for any one or more local, regional, national, and/or global drawings.

Minimum Drawings

In various embodiments of the invention configured for the administration of lotteries or other drawings, minimum prize values can be set and/or enforced by the administering system(s) 104, 108. For example, in a worldwide lottery multi-tier lottery involving a number of local and/or national lotteries through the use of kicker tickets, as described herein, a minimum award, such as $100 million dollars or euros, to be paid to winning contributors/participants can be announced and thereafter enforced. It has been found that the establishment of sufficient minimum prizes can have the effect of increasing participation in a drawing and therefore the amount of contributions and the amount of funds available for distribution to causes such as charities.

Collection Processes

In various further aspects the invention provides systems, devices, methods, and computer programming products for collecting funds in accordance with the disclosure herein.

For example, in various embodiments the invention provides cellular telephones 120, 124 and other palm-based computer devices 120, 126, and/or interactive TV devices 132 and corresponding methods and computer programming products, configured for contribution of funds/purchase of tickets or receipts through direct home or private connection to local collection and distribution systems 104 in accordance for the invention; and for creating, receiving, forwarding, and otherwise processing related communications, such as communications comprising promotional and other information.

In various further embodiments contributors wishing to participate in drawings or otherwise provide funds for collection in accordance to the invention can communicate for that and other purposes with any one or more of systems 102, 104, 148, 150, 108, etc., by means of computers connected to telecommunications networks such as the Internet, or other public and/or private communications networks, including for example desktop, laptop, or palmtop computers, by means of voice or touch tone telephone calls using landline telephones 134 and/or other communications using the public switched telephone network or other telecom network; or by any other suitably-adapted means, including, for example, those described in the Appendix.

Collection systems 102, and various forms of them, provide a very wide variety of possibilities for interacting with and collecting funds from contributors 101, particularly when coupled with other components of system 100, including for example any one or more of systems 104, 106, 108, 110, 112, 116. For example, cell phones, PDAs and other hand-held devices, PCs, point-of-sale countertop systems, and other interface devices employed as or incorporated within collection systems 102 can be configured to provide interactive interfaces which enable wide ranges and degrees of interaction with contributors. For example, various forms of static and/or interactive content may be displayed, including for example advertising and/or interfaces which allow individual users, including contributors 101, to select, vote for, or otherwise designate distributees to whom such individuals insist or desire that their own and/or others' contributed funds to be distributed.

Such and other interfaces can be provided in a very wide variety of contexts. For example, dedicated contributions systems 102 may be provided which provide single- or limited-purpose interfaces which deal solely or directly with the provision of contributions for distribution through the system(s) 100; and/or generalized, shared, or other multi-purpose interfaces my be provide through, for example, network websites accessible via the Internet and/or other freely-accessible networks. For example, advertising, explanatory, and/or other content may be provided, together with contribution(s) interfaces, via social networking and.or other systems, which may for example include pre-existing and/or independently-controlled or -operated networks.

Receipts such as tickets issued in connection with the remittance or contribution of funds electronically using such devices can be issued in electronic format. The use of such devices in the contribution of funds, e.g., through the purchase of tickets or other receipts for participation in a lottery-type funds distribution scheme, can be verified and otherwise controlled through the use of suitably-adapted devices and algorithms to provide, for example, suitable levels of security. For example, the use of a handheld device 120 such as a cellphone 124 or palmtop computer 126 to purchase a ticket in a lottery can be conditioned on authentication through the accessing of data files associated with the device 120 or a user thereof, as for example through the use of a personal information management (PIM) card or other device, and processing of data stored therein. For example, the purchase of a ticket using a cell phone 124 can be verified or authorized through checking of a billing or other information file associated with a subscriber owning or otherwise associated with the operation of the device.

As a further example, the use of a cellular telephone or other mobile communications device 120, 124, palmtop computer 120, 126, laptop computer, ITV 132, telephone 134, or computer connected to a computer network to make a contribution, e.g., purchase a lottery ticket, using a particular local collection and distribution system 104 such as a local lottery, can be controlled or verified based on a number of factors associated with the particular usage of the particular device 120. Such parameters can include, for example, the network cell or other connection from which the contributory communication originated, e.g., a telephone area code or country code; or a country code, area code, or address associated with a billing reference associated with an account governing use of the device 120; and IP address, encryption layer SSL device, and/or suitably configured and controlled use of passwords and personal identification numbers (PINs).

Distribution Processes

In various further aspects the invention provides systems, devices, methods, and computer programming products for distributing funds, goods, and/or services in accordance with the disclosure herein.

Funds or other prizes collected in accordance with the invention, or otherwise designated for distribution to identified distributees, can, for example, be distributed to one or more recipients selected from a pool of contributors, e.g., drawing winners, as described herein; and/or distributed to one or more recipients who are at least potentially outside the pool of contributors—i.e., who are not selected from the contributor pool—according to predetermined protocols or criteria.

For example, in an embodiment of the invention adapted for the collection and distribution of funds to global or other extrajurisdictional charities, public works, or other causes, a percentage of collected funds can be distributed to one or more participants who have won a drawing, with one or more further percentages being distributed to such causes. For example, in one variation of such an embodiment of the invention a pool of funds contributed for participation in a multi-jurisdictional drawing can be distributed according to the following example breakdown:
29%-33% to a global prize fund to be awarded to the winner(s) of the multi-jurisdictional drawing
7%-18% to be held by the participating local collection and distribution systems 104 for distribution to second-tier guaranteed prize winners (e.g., each second-tier prize is divided by a predetermined amount, e.g., $1 million dollars, and distributed to a predetermined number of winners who came closest to matching the selected winning number)
   In some embodiments, the following two components are sometimes combined to account for approximately 30% of the total:
a) 18.125% distributed to local charitable causes selected or approved by the corresponding local collection and distribution system(s) 104, e.g., through the offices of corresponding local distribution agent systems 106
b) 12.5% distributed to public works funds selected or approved by the corresponding local collection and distribution system(s) 104, e.g., through the offices of corresponding local distribution agent systems 106
5-18% to be distributed to Interjurisdictional distribution agent system 110 for further distribution to extrajurisdictional distributees 112
15% distributed to administrators 108, 116, etc., for administrative, promotional, and other services

In these or other embodiments, and variations thereof, of the invention, collected contributions received by collection and distribution systems 104 may be apportioned such that each collecting system 104 jurisdictions agree to pay fixed amounts toward the various global, local, and interjurisdictional prize or distribution funds, the administrator fees for agents 108, 116, etc., and an amount to one or more umbrella charitable and/or public works funds (ie. WOBILO.org). Such fixed amounts can be tied to one or more global currencies such as the US dollar or the Euro. Ticket prices (i.e., incremental levels of contribution set for individual contributors 101) in various local jurisdictions can be offered in local currency(ies) at price(s) determined by the corresponding jurisdictions, as appropriate in view of market and other conditions, including charitable and/or public works needs. If currency fluctuations occur with regard to the relevant local currency(ies), local jurisdictions may still be obligated to pay the fixed fees and may determine whether or not they need to adjust the end price of the ticket to the consumer in order to maintain their margins (ie. for local income, distribution channel and operator). Under such scenarios every player world wide is contributes the same amount toward winning the same prize and therefore it is considered to be a fair investment globally. The difference will be that the game (offered locally) may have other varying features according to the local market in which the player, depending upon jurisdiction, may pay an overall price that is more or less than that offered in other jurisdictions.

As will be immediately understood by those skilled in the relevant arts, once they have been made familiar with this disclosure, a great many intra- and interjurisdictional distribution schemes are available in accordance with this aspect of the invention. The determination of schemes to be used for such distributions, including for example both the identity(ies) of non-contributing distributees and the amounts and proportions in which funds are to be distributed to any or all of the various recipients can be made wholly or partly by any of systems 104, 106, 108, 110, 116, or their controlling entities, and/or by winning or other contributors, or any combinations thereof. Any suitable schemes or mechanisms, including for example proportionally or representative voting schemes, may be used. Thus, in various embodiments, the invention provides systems and methods which enable communications and interactions within various contributor/distributee communities through, for example, global or other wide-area networks in such manner as to promote the awarding and distribution of prizes, and allocations to charitable and other causes, and provides an interactive platform for players and/or other participants to vote for the causes to which their contributions may be distributed, and conditions under which such distributions are to be made.

For example, an administrator of any or all of systems 104, 106, 108, 110, 116 can designate one or more distributees 112, 106, 118 prior to a drawing. Alternatively, or in addition, one or more charitable or other distributees can be chosen by any one or more of selected contributors or drawing winners, at the time of contribution/ticket purchase or after being selected as a winner. For example, in embodiments of the invention in which a cell phone, ITV or other devices is used to directly input contribution information, a contributor 101 may be provided an opportunity to identify definitively, or vote for or other otherwise take part in identifying, one or more distributees 106, 112, 118 to receive distributions in the case such contributor is identified as a winner in a lottery or other selection process. For example, such a contributor 101 may be provided an interactive screen comprising a drop-down, radio button, or other menu of eligible distributees, and/or an interactive input field in which information useful in identifying such distributees (such as an e-mail or IP address).

As a further alternative, any such distributees can be chosen by otherwise uninvolved parties, as for example by voting or other selection, either interactively using radio buttons or other devices as described above, or using other devices, such as participation in a reality-type television, radio, or webcast production.

Funds collected in accordance with the invention can be distributed through a number of logistical, fiduciary, or formal channels. For example, any such funds, whether to be distributed within or across single or multiple jurisdictions can, after collection, be delivered to one or more trusted agents 106, 110, such as trust holders or escrow accounts, for holding and distribution in accordance with the instructions of parties such as any or all of systems 104, 108, and/or contributors 101.

Thus funds collected in accordance with the invention may be collected in one or more jurisdictions and distributed in other jurisdictions, in which they were or were not wholly or partially collected; and they may be distributed wholly or partially to account(s) associated with party(ies) who did or did not contribute.

Moreover, funds collected in a first tier or set of tiers of collection, such as for example in connection with a first tier drawing, can be distributed without regard to funds collected in other tiers of collection, as for example in a second-tier drawing involved the purchase of ‘kicker’ tickets.

In various embodiments of the invention, funds or portions thereof to be distributed to local causes through, for example, local distribution agent systems 106, can be distributed according to a requirement that they be spent or otherwise invested or applied within a jurisdiction associated with a corresponding collection and distribution agent 104. For example, funds collected by a specific collection and distribution system 104 can be required to be wholly or partially operated, controlled, and/or located from or within a jurisdiction associated with that system 104.

Additional Features

Collections and/or distribution schemes implemented in accordance with the invention can be promoted, and collections solicited, through the use of processes implemented via administration and promotion services systems 116. Such systems can include, for example, advertising systems and/or service provider systems including or otherwise interfacing with Internet search engines, social interaction websites, or other services, using for example known advertising and hyper-linking schemes and technologies.

Promotional and other administrative efforts may be supported through the use of video or other graphic devices indicating, for example, aggregated amounts of funds collected, in real- or near-real time, or on for example a periodic basis or following uniform or system delay(s). For example, graphic devices showing animations representing rolling series of counters can be used to show actual or approximate values of funds available to be won or otherwise distributed through use of the system 100. Such displays may be provided on actual, quasi, or pseudo real-time, periodic, or other suitable or desired bases. Such displays may be provided by any one or more of system(s) 104, 108, 116, 128. Such displays may be provided with any suitable or desired form of branding or source identification, including for example branding provided by ‘white labeling’ processes (e.g., the identification of sponsors, etc., other than the actual provider of the information).

In various aspects, the invention provides systems according to the foregoing which, suitably modified, may be applicable to distribution of goods.

As will be apparent to those skilled in the relevant arts, once they have been made familiar with this disclosure, relations between collection and distribution entities and other parties operating as part of or in cooperation with the various components of system 100 can be determined, in whole or in part, by, for example, legal and/or regulatory requirements such as currency exchange laws and/or tax regulations. Depending upon the nature of such relations, regulations, etc., various forms of marketing, distribution, and administrative advantage may be gained.

As will be understood by those skilled in the relevant arts, each of contributor systems 102; local collection and distribution systems 104; local distribution agent systems 106; service agent systems 108; administration and promotion systems 116: and interjurisdictional distribution agent systems 110; and any systems operated by or on behalf of local distributees 118 and/or extrajurisdictional distributees 112 can comprise any one or more data processor(s), computer(s), and/or other system(s) or device(s), and necessary or desirable input/output, communications, control, operating system, and other devices, including software, that are suitable for accomplishing the purposes described herein. For example, any or all such systems can comprise one or more general-purpose data processors provided on one or more circuit boards, as provided by for example Intel, IBM, Hewlett-Packard, and a number of other producers, using a LINUX, UNIX, Apple, IBM ESA 390 (S390) or Microsoft general-purpose operating system and suitable navigation application software programs, will suffice. A large number of suitable devices are now available and will doubtless hereafter be conceived and developed. The selection of suitable components to serve as and/or with such processors, including support and control components and software, in accordance with the invention, will not present difficulty to those of ordinary skill in the relevant arts once they have been made familiar with this disclosure.

As will be further understood by those skilled in the relevant arts, the various (sub)systems and their components 102, 104, 106, 108, 110, 112, 116, 118, etc., of system(s) 100 will each typically comprise one or programmable processors, communications gateways and other systems and/or interface(s) coupled to such processor(s) through which input and output signals may be provided, and machine-readable memory(ies) coupled to such processor(s); the memory(ies) storing instructions that, when executed by the processor(s), cause the system and its various components to execute the various process(es) described herein.

### EXAMPLES

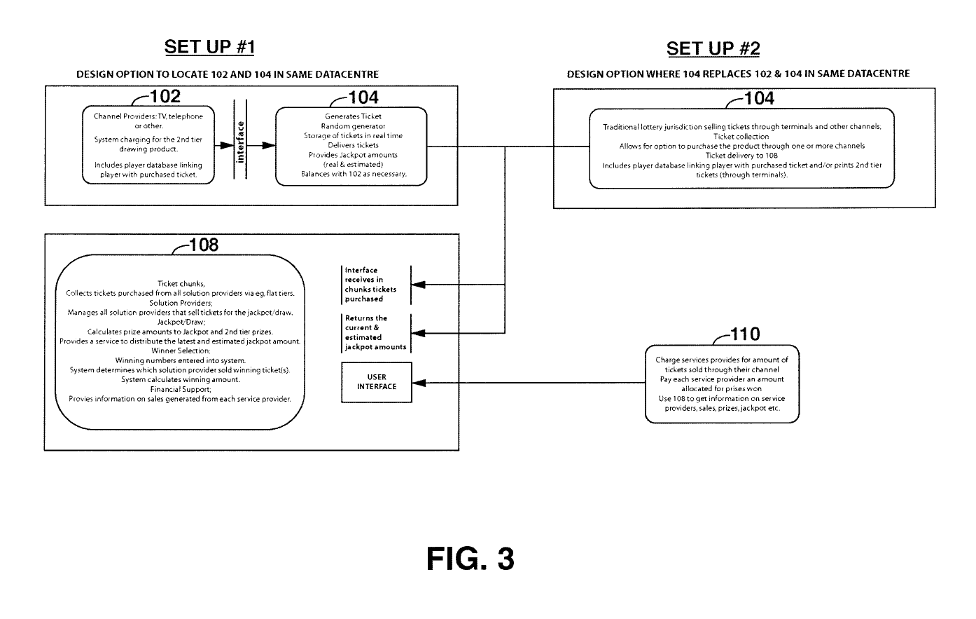

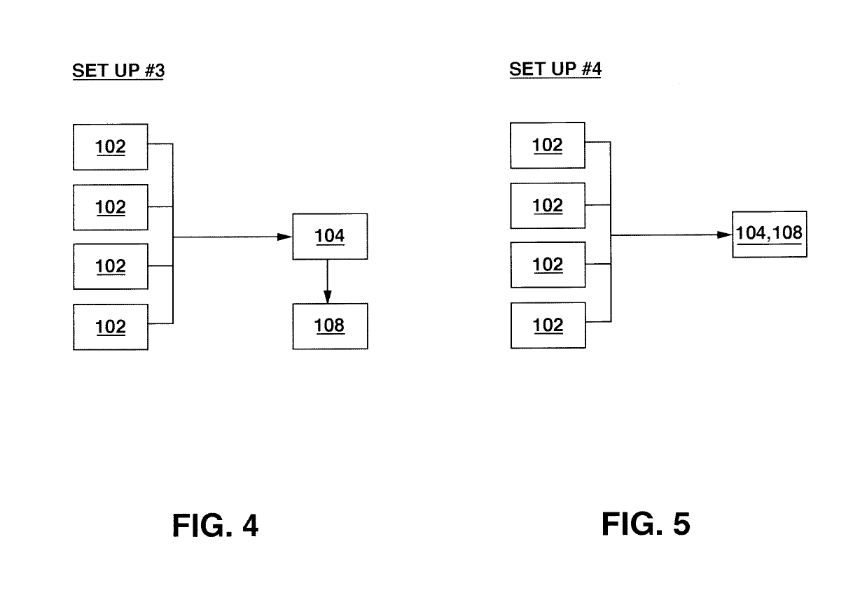

FIGS. 3-5 are schematic diagrams of alternative embodiments of computer communications networks suitable for use in collecting and distributing funds in accordance with various aspects of the invention. The embodiments shown in FIGS. 3-5 are particularly well suited to the implementation of various forms of multi-tier lottery or drawing systems as described herein, and can include features noted in the Figures.

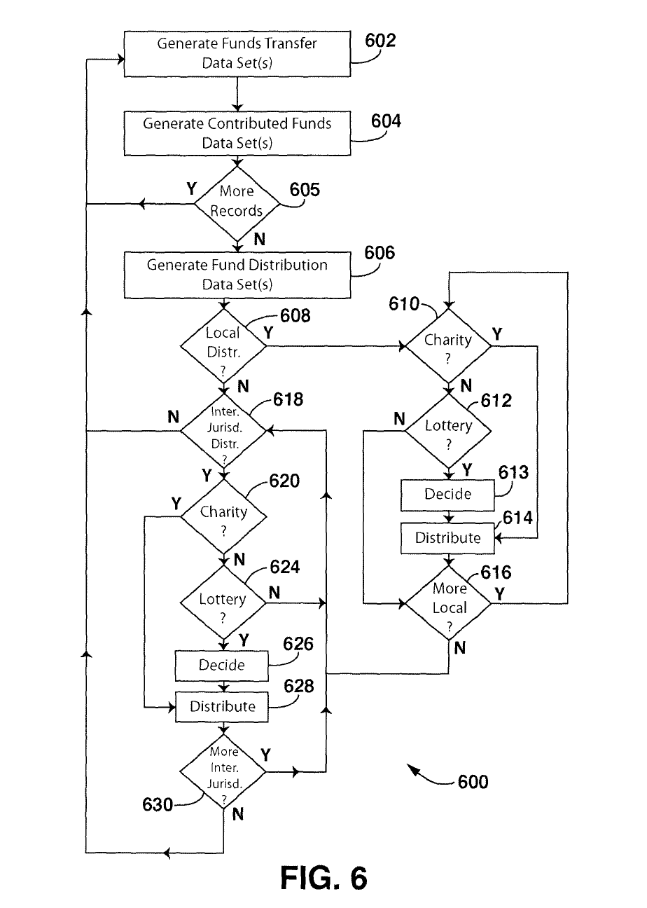

FIG. 6 is a schematic flow diagram illustrating an embodiment of a process for collection and distribution of funds in accordance with various aspects of the invention. Process 600 of Figure is suitable for implementation using, for example, any of systems 100 shown in FIGS. 1 and 3-5, and the various subsystems and components shown therein and described in connection thereto.

At 602 one or more funds transfer signal sets representing funds to be provided by, for example, any one or more individual contributors 101 may be generated, using, for example any one or more of the contributor (sub)systems 102 described herein. Such funds transfer signal sets can comprise any one or more signals representing information suitable for use in the contribution, collection and distribution of funds as described herein. For example, such a funds transfer signal set can comprise signals representing:
an identifier associated with the contributor 101 of the funds represented by the signal set; and
one or more amounts of funds to be contributed by the contributor of funds.

The identifier associated with the contributor 101 of the funds can be useful for a variety of purposes, included tax reporting and other accounting processes, and, in various embodiments, for providing to such contributor(s) 101 winnings or other distributions, as described herein. Such identifier(s) can include, for example, ticket numbers and/or other identifiers provided to the corresponding contributor(s) 101 using, for example, a ticket such as those shown in FIG. 2.

In various embodiments, a single funds transfer signal set can comprise signals representing more than one amount of funds to be contributed. For example, in embodiments implemented for distribution to multiple distributees, such as for example one or more local charities and one or more interjurisdictional charities, and/or in embodiments in which multiple-level lotteries and/or other algorithms are implemented, various subtotals intended for collection within and distribution in accordance with such various schemes or algorithms may be identified.

Funds transfer signal sets generated according to this aspect of the invention can include any one or more suitable signals, including, for example, in embodiments of the invention in which contributor(s) 101 are enable to designate any one or more distributee(s) 118, 112 to receive, or to conditionally receive any portion(s) of their contributions, corresponding identifiers of such distributee(s) 112, 118.

As will be understood by those skilled in the relevant arts, funds transfer and other data sets generated in accordance with the invention may be generated, communicated, and/or interpreted according to any one or more suitable format(s) or protocol(s), including for example the Financial Exchange (FIX) or other protocol(s). Communications between the various (sub)systems 102, 104, 106, 108, 110, 112, 116, 118, etc., may be accomplished using a single such protocol, or many, through the use of suitably-configured data translators, etc.

Data useful for generating funds transfer data sets at 602 may be generated by, and received by funds collection system(s) 104 by any suitably-configured data input generators, including for example specially-configured lottery or other point-of-sale terminals, cellular telephones and/or other mobile communications devices, or computers executing suitably-configured Internet or other network interfaces.

Funds transfer data (or signal) sets generated at 602 may be received and further processed by any of collection systems 104, 106, 110, etc., operating at, for example, a first- or subsequent level or layer of a single- or multi-tier lottery or other collection system.

At 604 the collection system(s) 104 which have received funds transfer signal sets generated and communicated at 602 can use the received signals to generate one or more contributed funds signal sets, for use in, for example, collecting and sorting contributions to be used for various purposes. Such contributed funds signals sets can include data useful for identifying funds contributed by individual contributors 101. For example, a contributed fund signal set may comprise one or more signals representing:
the amount of funds contributed by each of a plurality of contributors associated with the plurality of received funds transfer signal sets; and
an identifier associated with each of the corresponding contributors.

Any one or more contributed funds signals sets generated at 604 can comprise signals representing funds to be distributed by any one or more distribution agent systems 106, 110 to any one or more distributees 112, 118. Thus any one or more of such signal sets can comprise identifiers associated with any number of distribution agent(s) 106, 110 and/or distributee(s) 112, 118, and data representing any amount(s) of funds to be distributed thereto. The use of such identifiers is, for example, useful where contributor(s) 101 have provided indications of distributee(s) 112, 118 to whom they would like funds to be distributed.

The process 602-604 can repeat until there are no more funds transfer data records to be received, or until such time when, as described herein, it is desired to distribute collected funds to any one or more distributee(s) 112, 118. At such time, at 606 a collection and distribution system 104 having control of funds to be distributed can generate any one or more funds distribution signal sets, which signal sets can, for example, comprise signals representing:
an identifier associated with each of one or more distributees to whom contributed funds are to be distributed; and
an amount of funds to be distributed to each of the one or more distributees.
   wherein distribution of funds to at least one of the distributees is subject to regulation according to an authority associated with a jurisdiction other than an authority subject to which the distributed funds were contributed.

Funds distribution signal sets generated at, for example, 606 can be generated using identifier(s) and amount(s) determined according to any of the rules, algorithms, and/or processes described or otherwise suggested herein. For example, at 608 a determination can be made whether any funds to be distributed are to be distributed to any one or more local distributees and/or agents 118, 106, including for example any individual local contributors 101.

If at 608 it is determined that funds are to be distributed to one or more local distributees, at 610 it may be determined whether such local distributees comprise any charities or other distributees who have not contributed funds, and if appropriate corresponding funds distribution signal sets(s) can be generated and forwarded by the generating system(s) 104 to the corresponding local distribution agent system(s) 106 and/or directly to the corresponding local distributee(s) 118.

At 612 it may be determined whether such local distributees comprise, or are to comprise, any individual contributor(s) 101, as for example in cases where such contributor(s) have won lotteries or other games or distribution schemes, or where at 613 such schemes are decided, and if/as appropriate corresponding funds distribution signal set(s) can be generated, or sets generated at 606 can be accessed, and at 614 forwarded by the generating system(s) 104 to the corresponding local distribution agent system(s) 106 and/or directly to the corresponding local distributee(s) 118. Such signal set(s) may then be used to complete the transfer of funds from any one or more contributor(s) 101 to distributee(s) 118.

As indicated at 616, the process 610-614 can continue until all desired local distributions have been completed.

If at 608 or 616 it is determined that no more funds are to be distributed to local distributees, at 618 it may be determined whether funds are to be distributed to one or more interjurisdictional distributees. Where no lottery or other contingent distribution plan is to be applied, corresponding fund distribution data set(s) can be generated at 628 and forwarded to the corresponding distributee(s).

If at 624 it is determined that a lottery or other contingent distribution scheme is to be applied, at 624 the outcome of the contingent scheme can be determined and at 628 corresponding fund distribution data set(s) can be generated, or previously-generated records can be accessed, and forwarded to the corresponding distributee(s).

As indicated at 630, the process 620-628 can continue until all desired local distributions have been completed.

Optionally, distribution of funds at 614 and/or 628 to a charity or other distributee at 610, 620 can be made contingent upon the identification of a winner of a lottery at for example 612, 624.

Further features suitable for use in collecting and distributing funds in accordance with various aspects of the invention may be described. Such aspects are particularly useful in implementing various forms of multi-tier lottery or drawing systems as described herein. In the following:
GLA can correspond to an operator of any one or more of systems 102, 104, 108, 116.
GLN means any one or more portions of system 100.
Local Retailer can correspond to any one or more of systems 102
ITV means interactive television
WBL can correspond to an operator of any one or more of systems 102, 104, 108, 116, 128.
GGA can correspond to any one or more of systems 106, 110
Telco means telecommunications operator.
WOBILO is a suitable name for a lottery implemented in accordance with the invention.

Transaction Flows:

1. For a multi-tier totter implementation, a contributor 101 wishing to participate may be required to purchase a first-level, or base product, ticket, in order to be able to participate in a higher-level “WOBILO” process. In other embodiments, the higher-level, e.g. “WOBILO”, product may be bought a stand-alone ticket, without need for the purchase of a base ticket.

a. A receipt number or other contributor identifier 202, 204 may be randomly (or pseudo-randomly) generated by ticket-generation software operated by either a first-tier, single-jurisdiction operator 104, etc., or by an upper-tier and/or multi-jurisdictional GLA operator system 104, 116, etc.

b. The generated number can be requested or provided to any one or more of (i) a local retailer terminal located within the jurisdiction of purchase, (ii) a mobile handset application that resides on a handset (e.g, a mobile device) used by a contributor 101; (iii) an internet application residing on a web site of a service provider, (iv) an ITV in a hotel room, restaurant, etc.; or (v) by methods hereafter developed.

c. The contributor 101 buying the higher-level “WOBILO” ticket or kicker can elect any of: (i) buying the ticket from a local retailer using a cash, credit, debit, pre-paid card, gift card, or other electronic funds transfer (ETF) device; (ii) buying the WOBILO kicker by mobile device, using any suitable ETF mechanism, such as credit card number or money residing in a designated account; (iii) accessing the WOBILO website via the internet, or (iv) via ITV.

Purchase of WOBILO or other base- or higher-level tickets may also be facilitated through the use specialized applications provided for mobile devices, or as services offered by cellular or other mobile service providers, a cable or satellite television provider, etc., as a part of a service package, including for example a monthly service package.

A WOBILO or other multi-tier drawing may be decided by provision of flat files from each local lottery administered by a system 104, for example, to a centralized GLA database, and/or a central clearing house 116, 128, where a random winner identifier will be generated and matched against all numbers generated by local systems 104 for a weekly or other lower-tier drawing; or

Each participating lower-level lottery can review the numbers it generated for its own participants 101, and provide a flat file with the winning number(s) to the centralized GLA system, so that each local lottery 104 can cross-reference its numbers with the selected winning number;

If there is an upper-tier winner, the jurisdiction 104 in which the ticket was purchased can be authorized to announce the winner and collect any applicable local taxes;

If there is no upper-tier winner, the jackpot (pool of collected contributions) can be rolled over into a subsequent monthly, weekly, etc., draw.

Alternatively, such lotteries can be decided by higher-level or multi- or cross-jurisdictional agents or authorities, such as for example any one or more of service agent(s) 108, 128, 116, etc.; and local or lower-tier winners, etc., can be notified through the use of flat files and/or other suitable data structures.

Lotteries or drawings, or other collection and distribution schemes implemented in accordance with the invention may accommodate unlimited numbers of jurisdictions, locally or globally, and unlimited numbers of players. Moreover, there is no need for consensus between jurisdictions. Jurisdictions need not agree with each other in terms of various lottery, drawing, or other distribution schemes. Individual jurisdictions can, where not inconsistent with other requirements, set their own rules.

As will be further understood by those skilled in the relevant arts, communications between any or all of such processors and any or all of the components of system(s) 100 can be implemented using any suitable computer communications systems and protocols, including for example the Internet or other public or private computer and/or telecommunications network(s). Such systems can use wired, wireless, Bluetooth, or any other desired and/or suitable communications means. A large number of suitable devices and protocols are now available and will doubtless hereafter be conceived and developed. The selection of suitable components and protocols to serve such purposes will not present difficulty to those of ordinary skill in the relevant arts once they have been made familiar with this disclosure.

While the invention has been described and illustrated in connection with specific, presently-preferred embodiments, many variations and modifications may be made without departing from the spirit and scope of the invention. The invention is therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described. The scope of the claims is to be defined solely by the appended claims, giving due consideration to the doctrine of equivalents and related doctrines.

What is claimed is:

1. A system useful for processing signals useful in effecting the intra- and inter-jurisdictional transfer of funds, the system comprising at least one programmable processor, an interface coupled to the at least one processor through which input and output signals may be provided, and at least one memory coupled to the processor; the at least one memory storing instructions that, when executed by the at least one processor, cause the system to:
receive a plurality of funds transfer signal sets, each of the plurality of funds transfer signal sets comprising signals representing:
an identifier associated with a contributor of funds; and
at least one amount of funds contributed by the contributor of funds;
generate at least one contributed funds signal set, each contributed funds signal set comprising signals representing:
an amount of funds contributed by each of a plurality of contributors associated with the plurality of received funds transfer signal sets; and
an identifier associated with each of the corresponding contributors of funds;
generate at least one funds distribution signal set, each funds distribution signal set comprising signals representing:
an identifier associated with each of one or more distributees to whom contributed funds are to be distributed; and
an amount of funds to be distributed to each of the one or more distributees;
wherein distribution of funds to at least one of the distributees is subject to regulation according to an authority associated with a jurisdiction other than an authority subject to which the distributed funds were contributed.

2. The system of claim 1, wherein at least a portion of the funds associated with the received funds transfer signal sets is in a currency associated with a first jurisdiction, and at least a portion of the funds associated with the generated funds distribution signal sets is in a currency associated with a second jurisdiction.

3. The system of claim 1, wherein distribution of funds to at least a second distributee is subject to regulation according to an authority associated with a same jurisdiction as the authority subject to which the distributed funds were contributed.

4. The system of claim 3, wherein the at least a second distributee is a contributor of funds.

5. The system of claim 4, wherein the at least a second distributee is identified as a distributee according to a random process.

6. The system of claim 4, wherein the at least a second distributee is identified as a distributee according to a pseudo-random process.

7. The system of claim 4, wherein at least a portion of the funds distributed to the at least a second distributee was contributed by a contributor subject to regulation according to an authority associated with a jurisdiction other than an authority subject to which the at least a second contributor contributed funds.

8. The system of claim 1, wherein at least one of the plurality of funds transfer signal sets is generated by a mobile communications device.

9. The system of claim 1, wherein at least one of the plurality of funds transfer signal sets is received via a digital communications network.

10. A method of processing signals useful in effecting the intra- and inter-jurisdictional transfer of funds, the method implemented by at least one programmable processor executing instructions stored in machine-readable memory that, when executed by the at least one processor, causes the system to:
receive a plurality of funds transfer signal sets, each of the plurality of funds transfer signal sets comprising signals representing:
an identifier associated with a contributor of funds; and
at least one amount of funds contributed by the contributor of funds;
generate at least one contributed funds signal set, each contributed funds signal set comprising signals representing:
an amount of funds contributed by each of a plurality of contributors associated with the plurality of received funds transfer signal sets; and
an identifier associated with each of the corresponding contributors of funds;
generate at least one funds distribution signal set, each funds distribution signal set comprising signals representing:
an identifier associated with each of one or more distributees to whom contributed funds are to be distributed; and
an amount of funds to be distributed to each of the one or more distributees;
wherein distribution of funds to at least one of the distributees is subject to regulation according to an authority associated with a jurisdiction other than an authority subject to which the distributed funds were contributed.

11. The method of claim 10, wherein at least a portion of the funds associated with the received funds transfer signal sets is in a currency associated with a first jurisdiction, and at least a portion of the funds associated with the generated funds distribution signal sets is in a currency associated with a second jurisdiction.

12. The system of claim 10, wherein distribution of funds to at least a second distributee is subject to regulation according to an authority associated with a same jurisdiction as the authority subject to which the distributed funds were contributed.

13. The system of claim 12, wherein the at least a second distributee is a contributor of funds.

14. The system of claim 13, wherein the at least a second distributee is identified as a distributee according to a random process.

15. The system of claim 13, wherein the at least a second distributee is identified as a distributee according to a pseudo-random process.

16. The system of claim 13, wherein at least a portion of the funds distributed to the at least a second distributee was contributed by a contributor subject to regulation according to an authority associated with a jurisdiction other than an authority subject to which the at least a second contributor contributed funds.

17. The system of claim 10, wherein at least one of the plurality of funds transfer signal sets is generated by a mobile communications device.

18. The system of claim 10, wherein at least one of the plurality of funds transfer signal sets is received via a digital communications network.

19. A method of administering a multi-jurisdictional lottery, the method performed by a data processor and comprising:
receiving a request to purchase a local lottery product from a contestant;
receiving a request to purchase a multi-jurisdictional lottery product as an addition to the local lottery product; and
producing a lottery number for the multi-jurisdictional lottery product for communication to the contestant,
wherein, a winner of the multi-jurisdictional lottery is determined based on a winning number generated by a central multi-jurisdictional lottery system.

20. The method of claim 19, wherein the request to purchase the multi-jurisdictional lottery product is received through a mobile device.

21. The method of claim 19, wherein the request to purchase the multi-jurisdictional lottery product is received through the internet.

22. The method of claim 19, wherein producing a lottery number comprises generating a random number.

23. The method of claim 19, wherein producing a lottery number comprises requesting the lottery number from the central multi-jurisdictional lottery system.

24. A method for distributing winnings for a multi-jurisdictional lottery, the multi-jurisdictional lottery being administered by a central multi-jurisdictional lottery system, tickets to the multi-jurisdictional lottery being sold to contestants by a plurality local lottery systems, each contestant receiving a lottery number from one of the plurality of local lottery systems, the method comprising:
generating a winning number;
determining the jackpot amount;
allocating a first portion of the jackpot amount to one or more winning contestants where the lottery number received by each of the one or more winning contestants matches the winning number;
allocating a second portion of the jackpot amount to one or more local charities in one or more jurisdictions of the one or more of the plurality of local lottery systems which sold tickets comprising the winning number to the winning contestants; and
allocating a third portion of the jackpot amount to a global charitable organization to be administered to one or more recipients comprising one or more global charities.

25. The method of claim 24, wherein a percentage of the third portion is administered to one or more implementation partners of the global charitable organization.

26. The method of claim 24, wherein a percentage of the third portion is administered to one or more individuals chosen based on their charitable work.

27. The method of claim 24, wherein a percentage of the third portion is administered to aide one or more long term global problem.

28. The method of claim 24, wherein a percentage of the third portion is administered to aide one or more short term global crisis.
